(19) United States
(12) Patent Application Publication
(10) Pub. No.: US 2025/0035856 A1
(43) Pub. Date: Jan. 30, 2025

(54) OPTICAL CONNECTOR AND PRODUCTION METHOD FOR OPTICAL CONNECTOR

(71) Applicant: Fujikura Ltd., Tokyo (JP)

(72) Inventor: Keisuke Nishiguchi, Sakura-shi (JP)

(73) Assignee: Fujikura Ltd., Tokyo (JP)

(21) Appl. No.: 18/718,961

(22) PCT Filed: Sep. 21, 2022
(86) PCT No.: PCT/JP2022/035196

§ 371 Date: Jun. 12, 2024

(30) Foreign Application Priority Data
Jan. 14, 2022 (JP) 2022-004107

(51) Int. Cl. G02B 6/38; G02B 6/255

(52) U.S. Cl. CPC G02B 6/3826; G02B 6/2551; G02B 6/2558; G02B 6/3887

(57) ABSTRACT

An optical connector includes a ferrule that has a connection end face and a fiber hole; an embedded fiber that has an insertion portion inserted into the fiber hole, and an extension portion extending from the fiber hole; a connection fiber that is fusion-spliced to the extension portion; a temporary fixing member into which the extension portion is inserted; a heat-shrinkable sleeve that is shrunk by heating, accommodates a connection point of the two fibers, and is fixed to an end portion of the temporary fixing member; a plug frame that has a frame body portion and a regulating portion regulating relative movement of the ferrule with respect to the frame body portion; a tubular stop ring that has a biasing surface, and is locked to the plug frame; and a biasing member that is disposed between the ferrule and the biasing surface and biases the ferrule.

### TECHNICAL FIELD

The present invention relates to an optical connector and a production method for an optical connector.

Priority is claimed on Japanese Patent Application No. 2022-004107, filed Jan. 14, 2022, the content of which is incorporated herein by reference.

### BACKGROUND ART

In the related art, a field-assembly connector has been known as a structure in which an end portion of an optical fiber included in an optical fiber cable is used as a connector. The field-assembly connector generally adopts a floating structure in which a ferrule having a connection end face is movable relative to a connector body. The connector has the floating structure, and thus, it is easy to maintain a connected state between a connection end face of the connector and a connection end face of another connector.

Patent Document 1 discloses a fusion-splicing connector (fusion connector) that is an example of the field-assembly connector. In the fusion connector, an optical fiber (embedded fiber) included in the optical fiber cable and another optical fiber (connection fiber) fixed to the ferrule are fusion-spliced, and thus, an end portion of the embedded fiber is used as a connector (a terminal). In addition, in the connector of Patent Document 1, a housing has a structure that accommodates the ferrule, a spring bush, and a spring. The spring is disposed between the spring bush and the ferrule to bias the ferrule. Accordingly, a floating structure in which the ferrule is movable relative to the housing is implemented.

### CITATION LIST

### Patent Document

### [Patent Document 1]

Japanese Unexamined Patent Application, First Publication No. 2008-203463

### SUMMARY OF INVENTION

### Technical Problem

Incidentally, a connection point at which the connection fiber and the embedded fiber are fusion-spliced is likely to be fragile. Thus, in the fusion connector, a fusion point is generally protected by a fusion reinforcing body such as a heat-shrinkable sleeve (heat-shrinkable tube). Here, for example, in the configuration described in Patent Document 1, when the heat-shrinkable sleeve is shrunk, not only the heat-shrinkable sleeve but also the spring bush biased by the spring can be heated. Thus, there is a possibility that strength of the spring bush decreases as a temperature increases due to heating and the spring bush is deformed by a biasing force by the spring.

The present invention has been made in view of such circumstances, and an object thereof is to provide an optical connector and a production method for an optical connector, in which deformation caused by a biasing force generated by a biasing member is less likely to occur even when a heat-shrinkable sleeve is used.

### Solution to Problem

In order to solve the above problems, an optical connector according to a first aspect of the present invention includes a ferrule that has a first end at which a connection end face is provided and a second end positioned opposite to the first end and has a fiber hole formed to open in the connection end face, an embedded fiber that has an insertion portion inserted into the fiber hole, and an extension portion extending from the fiber hole toward the second end from the first end, a connection fiber that is fusion-spliced to the extension portion of the embedded fiber, a temporary fixing member into which the extension portion is inserted, a heat-shrinkable sleeve that is shrunk by heating, accommodates a connection point at which the embedded fiber and the connection fiber are fusion-spliced and is fixed to an end portion of the temporary fixing member, a plug frame that has a frame body portion accommodating at least part of the ferrule and the temporary fixing member, and a regulating portion regulating relative movement of the ferrule with respect to the frame body portion in an extension direction in which the extension portion extends, a tubular stop ring that has a biasing surface, accommodates at least part of the temporary fixing member and at least part of the heat-shrinkable sleeve and is locked to the plug frame, and a biasing member that is disposed between the ferrule and the biasing surface in the extension direction, and biases the ferrule in a direction from the second end toward the first end.

In addition, a production method for an optical connector according to a second aspect of the present invention includes preparing a ferrule that has a first end at which a connection end face is provided and a second end positioned opposite to the first end and has a fiber hole formed to open in the connection end face, an embedded fiber that has an insertion portion inserted into the fiber hole and an extension portion extending from the fiber hole toward the second end from the first end, a temporary fixing member into which the extension portion is inserted, and which has a temporary biasing surface, and a biasing member that is disposed between the ferrule and the temporary biasing surface in an extension direction in which the extension portion extends, and biases the ferrule in a direction from the second end toward the first end, fusion-slicing a connection fiber to the extension portion of the embedded fiber, shrinking a heat-shrinkable sleeve by heating while positioning a connection point at which the embedded fiber and the connection fiber are fusion-spliced inside the heat-shrinkable sleeve and fixing the heat-shrinkable sleeve to an end portion of the temporary fixing member, accommodating at least part of the ferrule, the temporary fixing member, and the biasing member in a plug frame, and locking a tubular stop ring having a biasing surface to the plug frame, separating the biasing member from the temporary biasing surface while bringing the biasing surface into contact with the biasing member, and sandwiching the biasing member between the ferrule and the biasing surface.

### Advantageous Effects of Invention

According to the above aspects of the present invention, it is possible to provide the optical connector and the production method for an optical connector, in which the deformation caused by the biasing force generated by the biasing member is less likely to occur even when the heat-shrinkable sleeve is used.

### BRIEF DESCRIPTION OF DRAWINGS

FIG. 1 is a perspective view showing an optical connector according to an embodiment of the present invention.

FIG. 2 is an exploded view showing the optical connector according to the embodiment of the present invention.

FIG. 3 is a sectional view taken along line III-III shown in FIG. 1 and is a diagram showing part of the optical connector according to the embodiment of the present invention.

FIG. 4 is a perspective view showing a ferrule according to the embodiment of the present invention.

FIG. 5 is a diagram of a flange portion of the ferrule shown in FIG. 4 as viewed from an arrow V.

FIG. 6 is a perspective view showing a plug frame according to the embodiment of the present invention.

FIG. 7 is a diagram of the plug frame shown in FIG. 6 as viewed from an arrow VII.

FIG. 8 is a perspective view showing a temporary fixing member according to the embodiment of the present invention.

FIG. 9 is a perspective view showing a stop ring according to the embodiment of the present invention.

FIG. 10 is a diagram showing the temporary fixing member and the stop ring according to the embodiment of the present invention are viewed from the front.

FIG. 11 is a sectional view taken along line XI-XI shown in FIG. 1 and is a diagram showing a state where the ferrule according to the embodiment of the present invention retracts.

FIG. 12A is a diagram showing a production method for an optical connector according to the present embodiment.

FIG. 12B is a diagram showing a state subsequent to FIG. 12A.

FIG. 12C is a diagram showing a state subsequent to FIG. 12B.

FIG. 12D is a diagram showing a state subsequent to FIG. 12C.

### DESCRIPTION OF EMBODIMENTS

### (Optical Connector 1)

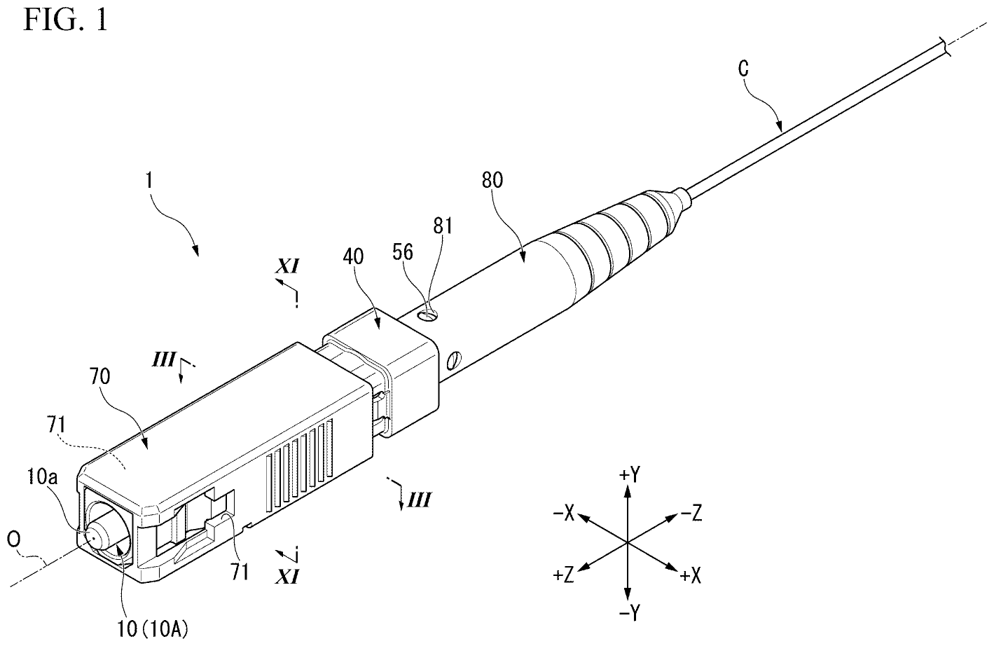

Hereinafter, an optical connector 1 according to an embodiment of the present invention will be described with reference to FIGS. 1 to 11.

As shown in FIGS. 1, 2, and 3, the optical connector 1 includes a ferrule 10, a temporary fixing member 20, a heat-shrinkable sleeve 30, a plug frame 40, a stop ring (spring bush) 50, a biasing member 60, a case 70, a boot 80, an embedded fiber F1, and a connection fiber F2. The optical connector 1 is provided at an end portion of an optical fiber cable C. The ferrule 10 has a first end E1 and a second end E2 positioned opposite to the first end E1. A connection end face 10a is provided at the first end E1 of the ferrule 10. A fiber hole 11 is open on the connection end face 10a.

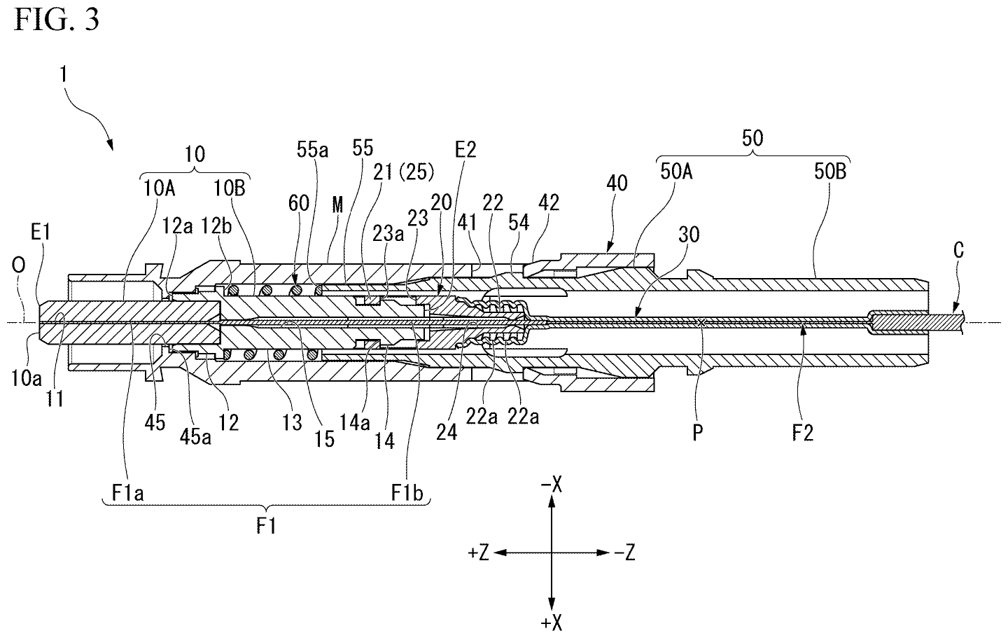

As shown in FIG. 3, the embedded fiber F1 is inserted into the fiber hole 11 such that a distal end of the embedded fiber F1 is exposed to the connection end face 10a. More specifically, the embedded fiber F1 has an insertion portion Fla inserted (accommodated) into the fiber hole 11, and an extension portion F1b extending from the fiber hole 11 from the first end E1 toward the second end E2. The insertion portion F1a of the embedded fiber F1 is fixed to the fiber hole 11 of the ferrule 10 by, for example, an adhesive.

### (Definition of Direction)

Here, in the present embodiment, a direction in which the extension portion F1b extends, that is, a direction in which the first end E1 and the second end E2 are aligned is referred to as a Z direction, an axial direction Z, or an extension direction Z. The extension direction Z is also a direction parallel to a central axis O of the fiber hole 11. The extension direction Z is also a longitudinal direction of the fiber hole 11. The extension direction Z is also referred to as a longitudinal direction Z. An orientation from the second end E2 toward the first end E1 of the ferrule 10 along the extension direction Z is referred to as a +Z orientation, frontward, or a distal end side. An orientation opposite to the +Z orientation is referred to as a −Z orientation, rearward, or a base end side. The extension portion Fib described above extends rearward from the fiber hole 11.

A section perpendicular to the extension direction Z is referred to as a transverse section. A direction orthogonal to the central axis O of the fiber hole 11 is referred to as a radial direction. Along the radial direction, an orientation closer to the central axis O is referred to as a radially inner side, and an orientation separated from the central axis O is referred to as a radially outer side. As viewed from the extension direction Z, a direction in which orbits around the central axis O of the fiber hole 11 is referred to as a circumferential direction.

In addition, one direction of the radial directions, that is, one direction orthogonal to the extension direction Z is particularly referred to as a first direction X. One direction along the first direction X is referred to as a +X orientation or rightward. An orientation opposite to the +X orientation is referred to as a −X orientation or leftward. A direction orthogonal to the first direction X in the radial direction, that is, a direction orthogonal to both the extension direction Z and the first direction X is referred to as a second direction Y. One orientation along the second direction Y is referred to as a +Y orientation or upward. An orientation opposite to the +Y orientation is referred to as a −Y orientation or downward.

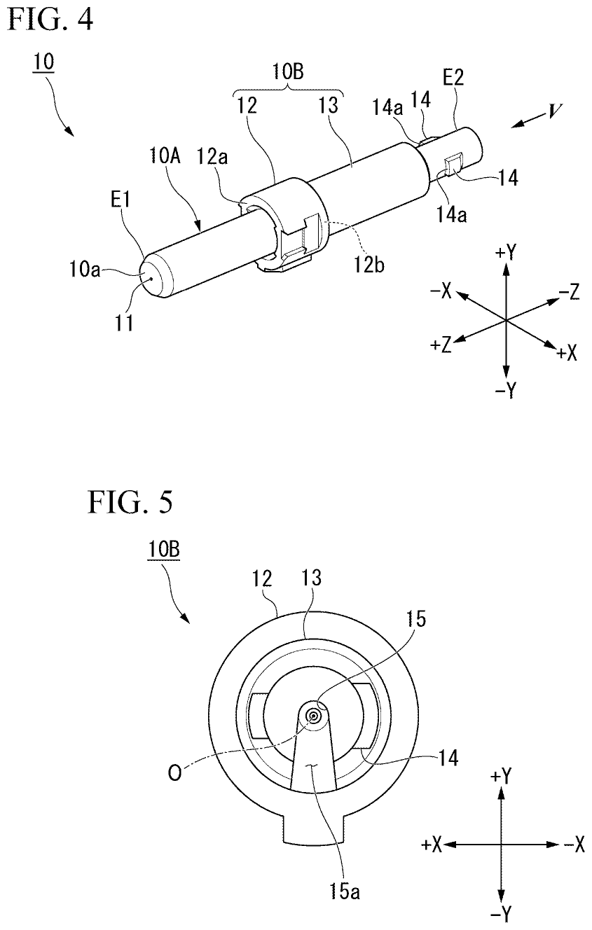

As shown in FIG. 4, the ferrule 10 has a ferrule body portion 10A and a ferrule flange 10B. The first end E1 of the ferrule 10 described above corresponds to a distal end of the ferrule body portion 10A. That is, the connection end face 10a is positioned at the distal end of the ferrule body portion 10A. In addition, the second end E2 of the ferrule 10 corresponds to a rear end of the ferrule flange 10B. In the present embodiment, the ferrule body portion 10A and the ferrule flange 10B are separately formed, but the ferrule body portion 10A and the ferrule flange 10B may be integrally formed.

As shown in FIG. 4, the ferrule body portion 10A is a cylindrical member extending in the extension direction Z. For example, zirconia can be used as a material of the ferrule body portion 10A. The fiber hole 11 opening at the connection end face 10a penetrates the ferrule body portion 10A in the extension direction Z.

As shown in FIG. 4, a rear end portion of the ferrule body portion 10A is held by the ferrule flange 10B. The ferrule flange 10B has a flange portion 12 and a sliding tubular portion 13.

The flange portion 12 is a tubular member and surrounds the rear end portion of the ferrule body portion 10A. The ferrule 10 is fitted inside the flange portion 12. The flange portion 12 has a regulated surface 12a facing forward and a biased surface 12b facing rearward (see also FIG. 3).

As shown in FIG. 4, the sliding tubular portion 13 extends rearward from the flange portion 12. An outer diameter of the sliding tubular portion 13 is smaller than an outer diameter of the flange portion 12. A pair of engaged portions 14 is formed in the sliding tubular portion 13. The engaged portions 14 according to the present embodiment are projections that protrude toward an outside in the first direction X from an outer peripheral surface of the sliding tubular portion 13. Each engaged portion 14 has an engaged surface 14a facing forward.

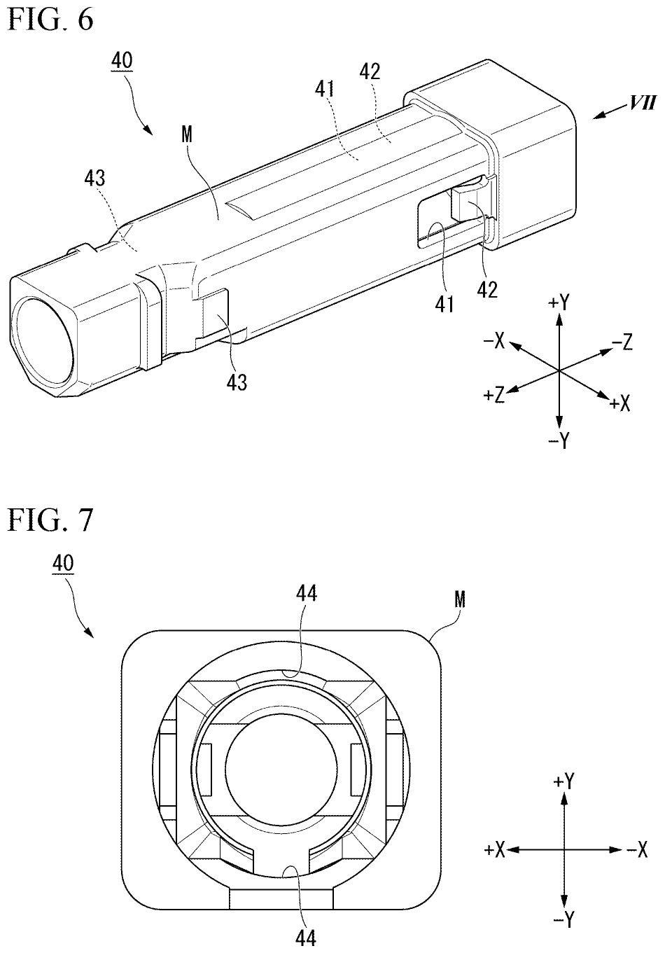

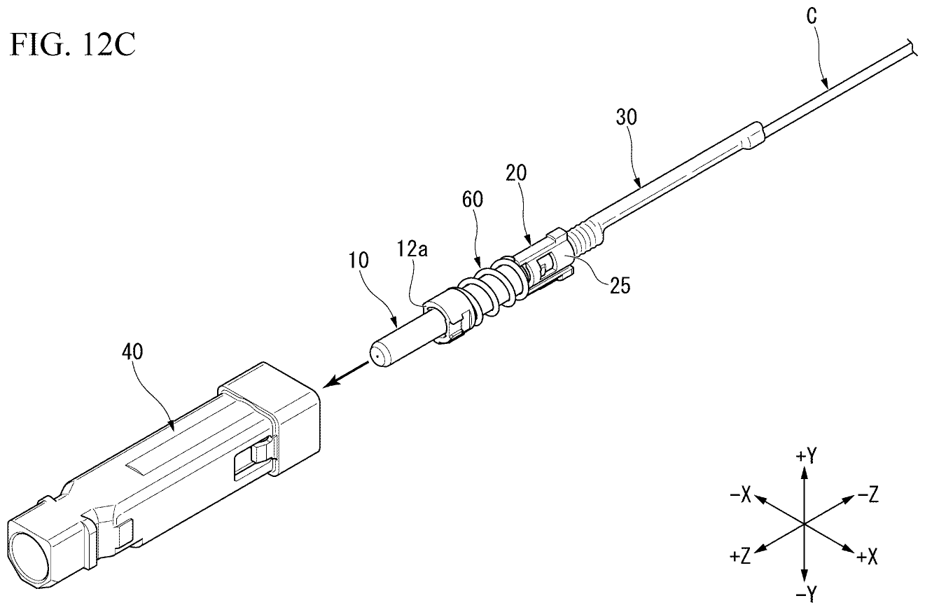

As shown in FIG. 3, a first communication hole 15 through which the extension portion F1b of the embedded fiber F1 is inserted is formed inside the sliding tubular portion 13. The first communication hole 15 penetrates the sliding tubular portion 13 in the extension direction Z. The first communication hole 15 communicates with the fiber hole 11 of the ferrule body portion 10A. In addition, as shown in FIGS. 5 and 11, a first flexure space 15a that broadens toward the radially outer side (downward in the shown example) from the central axis O as viewed from the extension direction Z is formed at a rear end portion of the first communication hole 15. The first flexure space 15a allows the embedded fiber F1 (extension portion F1b) to bend (details will be described later). An outer diameter of a rear end portion of the sliding tubular portion 13 is smaller than an outer diameter of a front end portion of the sliding tubular portion 13. As viewed from the extension direction Z, the engaged portions 14 provided at the rear end portion of the sliding tubular portion 13 are provided on the radially inner side from an outer peripheral surface of the front end portion of the sliding tubular portion 13 (see FIG. 5).

As shown in FIG. 3, the connection fiber F2 is fusion-spliced to a rear end of the embedded fiber F1 (extension portion F1b). That is, the optical connector 1 according to the present embodiment is a fusion-splicing connector (fusion connector) having fibers F1 and F2 fusion-spliced at a connection point P. Each of the embedded fiber F1 and the connection fiber F2 is an optical fiber and has a core and a cladding. The connection fiber F2 is an optical fiber embedded in the optical fiber cable C.

Note that, a work of providing the optical connector 1 at the end portion of the optical fiber cable C, that is, a work of fusion-splicing the embedded fiber F1 and the connection fiber F2 to each other, may be performed at a field where the optical fiber cable C is installed. Accordingly, the work (described later) of heating the heat-shrinkable sleeve 30, which is performed after the fusion-splicing, may also be performed at the field where the optical fiber cable C is installed.

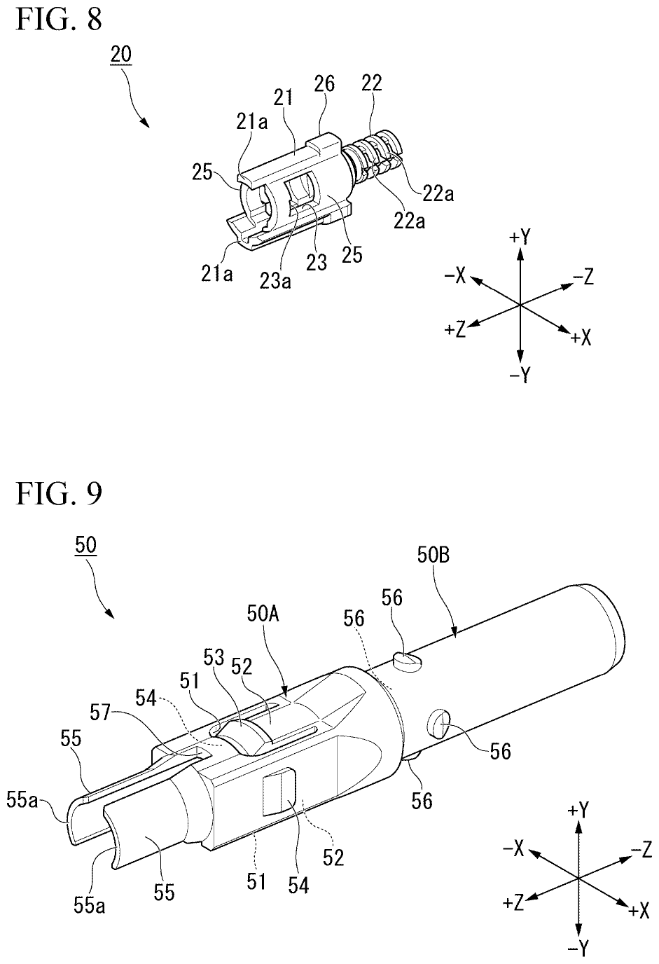

As shown in FIG. 3, the plug frame 40 has a frame body portion M and a regulating portion 45. The frame body portion M is a member extending in the extension direction Z, and is formed, for example, in a tubular shape. An outer shape of the frame body portion M according to the present embodiment is a quadrangle in sectional view (see also FIG. 6). The plug frame 40 (frame body portion M) according to the present embodiment accommodates at least part of the ferrule 10, the temporary fixing member 20, and at least part of the stop ring 50. However, the plug frame 40 may not accommodate at least part of the stop ring 50. The regulating portion 45 protrudes toward the radially inner side from an inner peripheral surface of the frame body portion M. The regulating portion 45 has a regulating surface 45a facing rearward.

Here, as shown in FIG. 3, the biased surface 12b of the flange portion 12 is biased forward by the biasing member 60. Thus, the ferrule body portion 10A held by the flange portion 12 (ferrule flange 10B) also receives a biasing force directed forward. That is, the ferrule 10 receives the biasing force directed forward as a whole. In this case, the regulated surface 12a of the flange portion 12 is brought into contact with the regulating portion 45 (regulating surface 45a) included in the plug frame 40. Accordingly, a forward relative movement of the ferrule 10 with respect to the plug frame 40 (frame body portion M) is regulated, and the ferrule 10 is prevented from falling off the plug frame 40.

As shown in FIG. 6, a first slit 41 and a first claw portion 42 are formed on each of a left surface (a surface facing leftward) and a right surface (a surface facing rightward) of the frame body portion M. That is, the frame body portion M has a pair of first slits 41 and a pair of first claw portions 42 that are symmetrically disposed in the radial direction. In addition, the pair of first slits 41 and first claw portions 42 are positioned at a rear end portion of the frame body portion M. Each first slit 41 has a C-shape that is open rearward as viewed from the first direction X. The first claw portion 42 is surrounded by the first slit 41. The first claw portion 42 is elastically deformable with respect to the frame body portion M, and is bent toward the radially inner side with respect to the frame body portion M.

As shown in FIG. 6, a second claw portion 43 is formed on each of a left surface and a right surface of the frame body portion M. That is, the frame body portion M has a pair of second claw portions 43 that are symmetrically disposed in the radial direction. In addition, the pair of second claw portions 43 are positioned at a front end portion of the frame body portion M. Each second claw portion 43 protrudes toward the radially outer side from an outer peripheral surface of the frame body portion M.

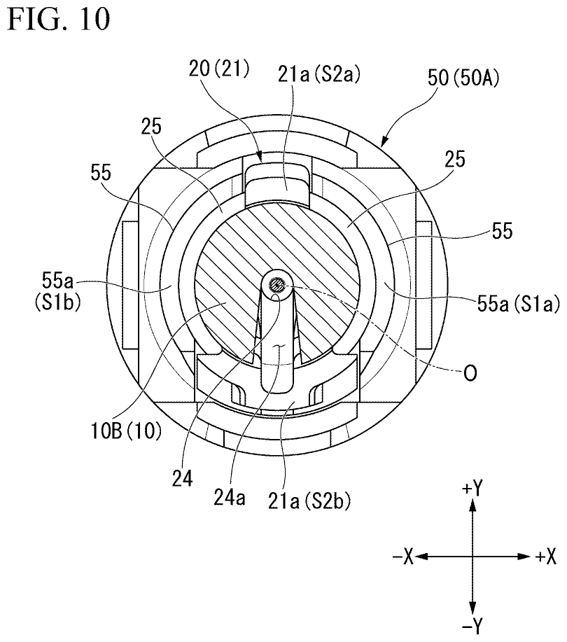

As shown in FIG. 7, the frame body portion M is formed with a pair of sliding concave portions 44 that are concave toward the radially outer side from the inner peripheral surface of the frame body portion M (see also FIG. 11). A shape of the sliding concave portion 44 according to the present embodiment is an arc shape in transverse sectional view. The pair of sliding concave portions 44 according to the present embodiment is disposed to face each other in the second direction Y.

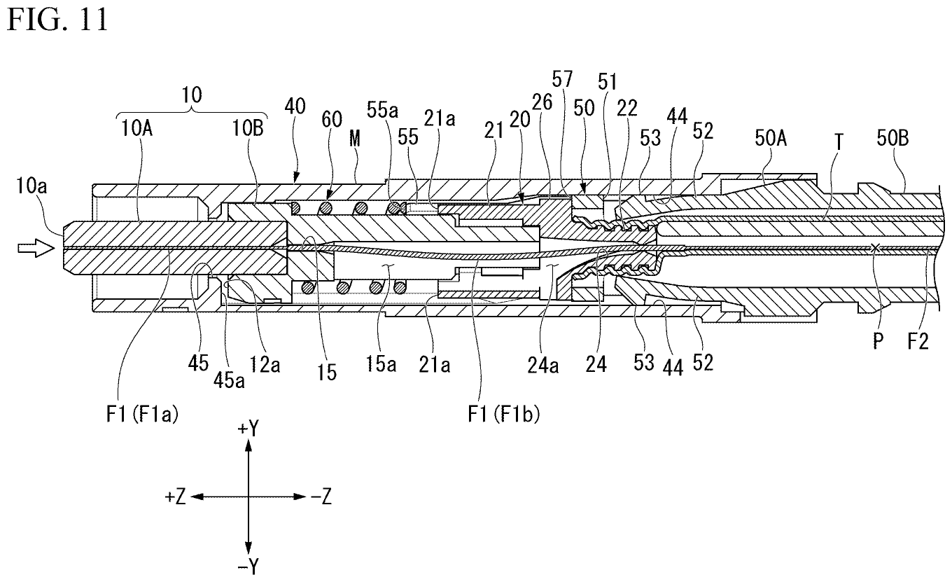

As shown in FIG. 8, the temporary fixing member 20 has a surrounding tubular portion 21 and a sleeve fixing portion 22. As shown in FIG. 3, the surrounding tubular portion 21 surrounds the rear end portion of the sliding tubular portion 13 of the ferrule 10 from the radially outer side. The sliding tubular portion 13 is slidable in the extension direction Z with respect to the surrounding tubular portion 21. However, the sliding tubular portion 13 may not be slidable with respect to the surrounding tubular portion 21 as long as the sliding tubular portion 13 and the surrounding tubular portion 21 can relatively move. For example, there may be a gap between the sliding tubular portion 13 and the surrounding tubular portion 21 in the radial direction.

As shown in FIG. 8, the surrounding tubular portion 21 is formed with a pair of concave portions 25 that is concave toward the radially inner side from an outer peripheral surface of the surrounding tubular portion 21. As viewed from the extension direction Z, a shape of the concave portion 25 is an arc shape. The pair of concave portions 25 according to the present embodiment is aligned in the first direction X. In addition, an engaging portion 23 is formed in each of the concave portions 25. The engaging portion 23 according to the present embodiment is a hole that is open on a bottom surface of the concave portion 25 and penetrates the surrounding tubular portion 21 in the radial direction. The engaging portion 23 has an engaging surface 23a facing rearward. In addition, a fitting convex portion 26 that protrudes toward the radially outer side (upward in the shown example) from the outer peripheral surface of the surrounding tubular portion 21 is formed at the surrounding tubular portion 21.

As shown in FIG. 3, the engaged portion 14 formed at the ferrule 10 is disposed inside each engaging portion 23. The engaged portion 14 and the engaging portion 23 are engaged, and thus, relative movement of the ferrule 10 with respect to the temporary fixing member 20 in the extension direction Z (forward) is regulated. In other words, the engaged portion 14 and the engaging portion 23 are engaged, and thus, the ferrule 10 and the temporary fixing member 20 are coupled. More specifically, the engaged surface 14a of the engaged portion 14 and the engaging surface 23a of the engaging portion 23 are brought into contact with each other, and thus, the relative movement of the ferrule 10 with respect to the temporary fixing member 20 is regulated.

As shown in FIG. 8, the surrounding tubular portion 21 has a temporary biasing surface 21a facing forward. That is, a front surface of the surrounding tubular portion 21 corresponds to the temporary biasing surface 21a. As shown in FIG. 11, the temporary biasing surface 21a faces the biasing member 60 in the extension direction Z. In addition, in the extension direction Z, the temporary biasing surface 21a is away from the biasing member 60.

As shown in FIG. 8, the sleeve fixing portion 22 is a tubular member extending rearward from the surrounding tubular portion 21. An outer diameter of the sleeve fixing portion 22 is smaller than an outer diameter of the surrounding tubular portion 21. A plurality of projections 22a that protrude toward the radially outer side from an outer peripheral surface of the sleeve fixing portion 22 are formed at the sleeve fixing portion 22. The plurality of projections 22a are disposed at intervals in the extension direction Z. However, the sleeve fixing portion 22 may not have the projections 22a.

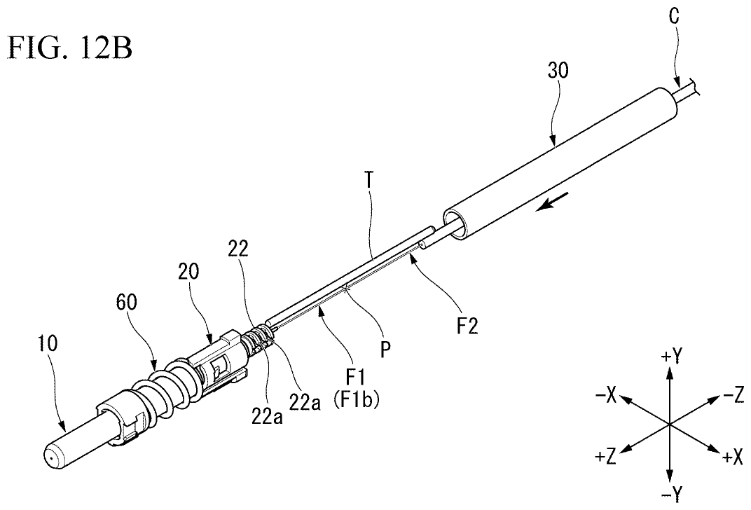

As shown in FIG. 3, a second communication hole 24 through which the extension portion F1b of the embedded fiber F1 is inserted is formed inside the temporary fixing member 20. The second communication hole 24 penetrates the temporary fixing member 20 in the extension direction Z. The second communication hole 24 communicates with the first communication hole 15 of the ferrule flange 10B. In addition, as shown in FIGS. 10 and 11, a second flexure space 24a that broadens toward the radially outer side (downward in the shown example) from the central axis O as viewed from the extension direction Z is formed at a front end portion of the second communication hole 24. Similarly to the first flexure space 15a, the second flexure space 24a allows the embedded fiber F1 (extension portion F1b) to bend (details will be described later).

As shown in FIG. 3, the heat-shrinkable sleeve 30 is a tubular member that extends in the extension direction Z shrinkable by heating. Although not shown, an adhesive layer is provided on an inner peripheral surface of the heat-shrinkable sleeve 30. The adhesive layer is made of a material that is melted by heating and is solidified again by cooling.

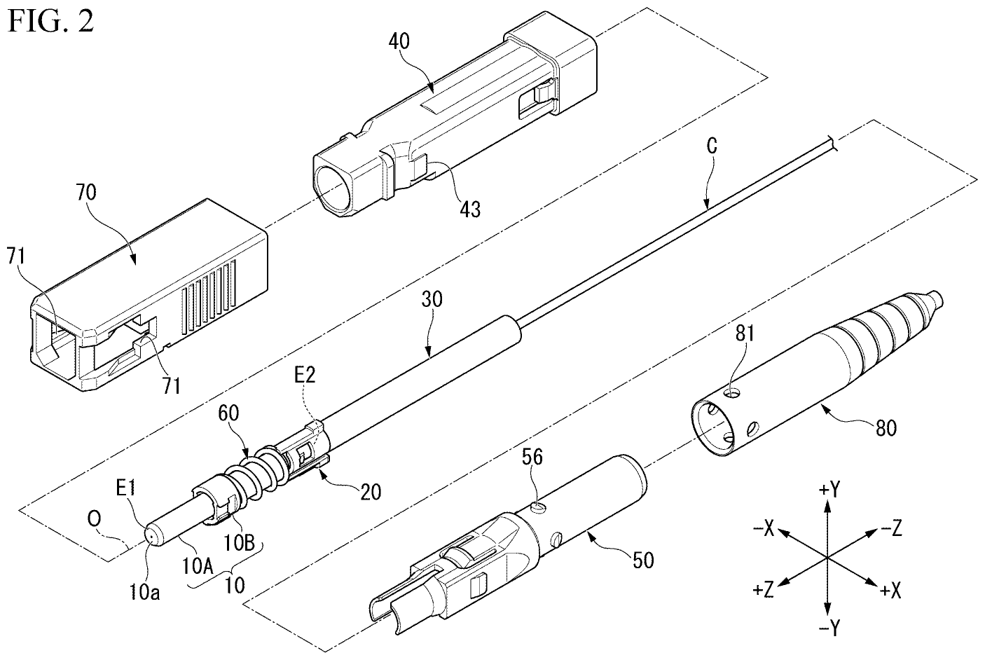

The heat-shrinkable sleeve 30 is fixed to an end portion (rear end portion) of the temporary fixing member 20 by shrinking by heating. More specifically, the heat-shrinkable sleeve 30 is heat-shrunk to tighten the projections 22a, and thus, the heat-shrinkable sleeve is fixed to the sleeve fixing portion 22 of the temporary fixing member 20. In addition, the heat-shrinkable sleeve 30 is heat-shrunk such that the connection point P at which the embedded fiber F1 and the connection fiber F2 are fusion-spliced is positioned. Accordingly, the heat-shrinkable sleeve 30 is fixed to the extension portion F1b and the connection fiber F2. Note that, FIG. 2 shows a state before the heat-shrinkable sleeve 30 is heat-shrunk. FIGS. 3 and 11 show a state after the heat-shrinkable sleeve 30 is heat-shrunk.

The heat-shrinkable sleeve 30 has a role of protecting the connection point P which is likely to be fragile and fixing the fibers F1 and F2 to the temporary fixing member 20. In addition, as shown in the example of FIG. 11, even when a rod-shaped tensile strength body T extending in the extension direction Z and disposed to be added to the connection point P may be accommodated inside the heat-shrinkable sleeve 30. According to this configuration, the connection point P can be more reliably protected. That is, the optical connector 1 may have a plate-shaped tensile strength body T.

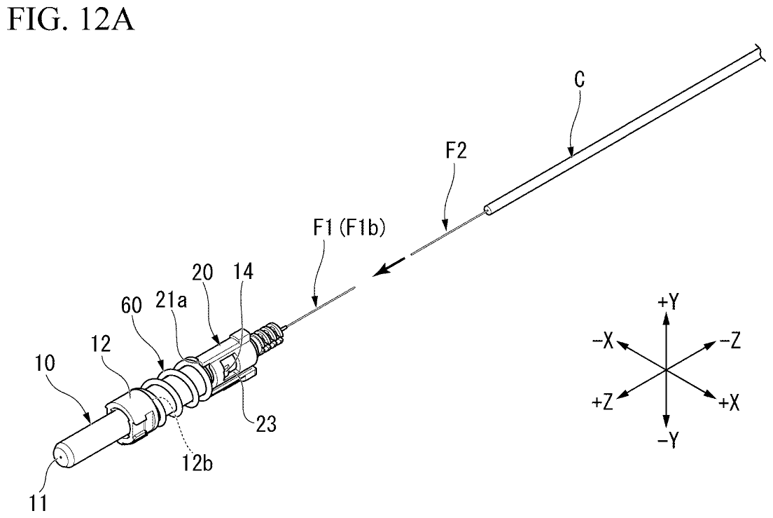

As shown in FIG. 3, the stop ring 50 is a tubular member that accommodates at least part of the temporary fixing member 20 and at least part of the heat-shrinkable sleeve 30. As shown in FIG. 9, the stop ring 50 according to the present embodiment has a first tubular portion 50A and a second tubular portion 50B each extending in the extension direction Z. The second tubular portion 50B is positioned rearward of the first tubular portion 50A. An outer shape of the first tubular portion 50A according to the present embodiment is a quadrangle in transverse sectional view. An outer shape of the second tubular portion 50B according to the present embodiment is a circle in transverse sectional view.

As shown in FIG. 9, a second slit 51 and a third claw portion 52 are formed on each of an upper surface (a surface facing upward) and a lower surface (a surface facing downward) of the first tubular portion 50A. That is, the first tubular portion 50A has a pair of second slits 51 and a pair of third claw portions 52 that are symmetrically disposed in the radial direction. Each second slit 51 has a C-shape that is open rearward as viewed from the second direction Y. The third claw portion 52 is surrounded by the second slit 51. Abase end portion (rear end portion) of the third claw portion 52 is connected to the first tubular portion 50A. A convex portion 53 that protrudes toward the radially outer side is formed at a front end portion of the third claw portion 52. The third claw portion 52 and the convex portion 53 are disposed within the sliding concave portion 44 of the plug frame 40 (see FIG. 11). The convex portion 53 is brought into contact with the sliding concave portion 44.

The third claw portion 52 is a portion that is elastically deformable with respect to the first tubular portion 50A. As shown in FIG. 11, the third claw portion 52 receives a force directed to the radially inner side by the plug frame 40 (sliding concave portion 44) brought into contact with the convex portion 53 and is inclined toward the radially inner side with the base end portion (base end side) as a base point. With this configuration, the third claw portion 52 presses the heat-shrinkable sleeve 30 against the sleeve fixing portion 22, and the heat-shrinkable sleeve 30 is more firmly fixed to the temporary fixing member 20. However, the stop ring 50 may not have the third claw portion 52.

As shown in FIG. 9, a fourth claw portion 54 is formed on each of a left surface and a right surface of the first tubular portion 50A. That is, the first tubular portion 50A has a pair of fourth claw portions 54 that are symmetrically disposed in the radial direction. Each fourth claw portion 54 protrudes toward the radially outer side from an outer peripheral surface of the first tubular portion 50A. As shown in FIG. 3, each fourth claw portion 54 meshes with the first claw portion 42 of the plug frame 40, and thus, the stop ring 50 is locked to the plug frame 40. More specifically, a rear surface (a surface facing rearward) of the fourth claw portion 54 and a front surface (a surface facing forward) of the first claw portion 42 mesh with each other, and thus, the stop ring 50 is locked to the plug frame 40.

As shown in FIG. 9, the stop ring 50 according to the present embodiment has a pair of protrusion portions 55 extending forward from the first tubular portion 50A. The pair of protrusion portions 55 is aligned in the first direction X. In addition, as shown in FIG. 10, a position and a shape of the protrusion portion 55 correspond to the shape of the concave portion 25 included in the temporary fixing member 20. The protrusion portion 55 is disposed toward the radially outer side from the concave portion 25 included in the temporary fixing member 20. Since the concave portion 25 is formed in the temporary fixing member 20, interference between the temporary fixing member 20 and the protrusion portion 55 of the stop ring 50 is avoided.

The protrusion portion 55 has a biasing surface 55a facing forward. That is, a front surface of the protrusion portion 55 corresponds to the biasing surface 55a. As shown in FIGS. 3 and 11, the biasing member 60 is disposed between the biased surface 12b of the ferrule 10 and the biasing surface 55a of the stop ring 50 in the extension direction Z. That is, the biasing member 60 is interposed between the biased surface 12b and the biasing surface 55a in the extension direction Z. The biasing member 60 is compressed between the biased surface 12b of the ferrule 10 and the biasing surface 55a of the stop ring 50, and thus, the above-described biasing force is generated. For example, a coil spring can be used as the biasing member 60.

As shown in FIG. 11, in the optical connector 1, the temporary biasing surface 21a of the temporary fixing member 20 is disposed rearward of the biasing surface 55a of the stop ring 50. As viewed from the extension direction Z, at least part of the biasing member 60 is disposed at a position overlapping the temporary biasing surface 21a of the temporary fixing member 20. As viewed from the extension direction Z, at least part of the biasing member 60 is disposed at a position overlapping the biasing surface 55a of the stop ring 50. As shown in FIG. 10, as viewed from the front, the temporary biasing surface 21a of the temporary fixing member 20 and the biasing surface 55a of the stop ring 50 do not overlap each other.

In the present embodiment, an area of the biasing surface 55a of the stop ring 50 is equal to or larger than an area of the temporary biasing surface 21a of the temporary fixing member 20 (see FIG. 10). Note that, in a case where the biasing surface 55a is divided into two or more regions, the “area of the biasing surface 55a” means a total value of areas of the divided two or more regions. Similarly, in a case where the temporary biasing surface 21a is divided into two or more regions, the “area of the temporary biasing surface 21a” means a total area of the divided two or more regions. That is, in the example of FIG. 10, the “area of the biasing surface 55a” means a total of an area S1a and an area S1b, the “area of the temporary biasing surface 21a” means a total of an area S2a and an area S2b, and S1a+S1b≥S2a+S2b is satisfied. Note that, as shown in the example in FIG. 10, the shapes of the two temporary biasing surfaces 21a may be different from each other. For example, of the two temporary biasing surfaces 21a, a width of the temporary biasing surface 21a in the circumferential direction, which is the area S2b where the second flexure space 24a is formed, is larger than a width of the temporary biasing surface 21a in the circumferential width, which is the area S2a. Accordingly, the areas of the biasing surface 55a and the temporary biasing surface 21a can be adjusted to satisfy the above expression while strength of the surrounding tubular portion 21 including the temporary biasing surface 21a and the second flexure space 24a are secured.

As shown in FIG. 9, a fitting concave portion 57 that is concave rearward from a front end of the first tubular portion 50A is formed at the first tubular portion 50A according to the present embodiment. The fitting concave portion 57 is open from the outer peripheral surface toward an inner peripheral surface of the first tubular portion 50A. In particular, the fitting concave portion 57 according to the shown example penetrates the first tubular portion 50A in the radial direction. As shown in FIG. 11, the fitting convex portion 26 included in the temporary fixing member 20 is fitted into the fitting concave portion 57. According to this configuration, when a tensile force directed rearward is applied to the connection fiber F2, the tensile force can be delivered to the stop ring 50 via the fitting convex portion 26 and the fitting concave portion 57. Accordingly, when the tensile force unexpectedly acts on the connection fiber F2, the embedded fiber F1 is less likely to be damaged.

As shown in FIG. 9, four fifth claw portions 56 are formed on the second tubular portion 50B according to the present embodiment. Four fifth claw portions 56 are disposed at equal intervals in the circumferential direction. As shown in FIGS. 1 and 2, each of four fifth claw portions 56 is disposed within each of four windows 81 formed in the boot 80. Accordingly, the boot 80 is attached to the second tubular portion 50B. Note that, the optical connector 1 may not include the boot 80.

As shown in FIGS. 1 and 2, the case 70 is a tubular member extending in the extension direction Z. An outer shape of the case 70 according to the present embodiment is a quadrangle in transverse sectional view. The case 70 accommodates at least part of the plug frame 40. A window 71 that is symmetrically disposed in the radial direction is formed in the case 70. The second claw portion 43 of the plug frame 40 is disposed within the window 71 of the case 70. With this configuration, the plug frame 40 is prevented from falling rearward from the case 70. Note that, the optical connector 1 may not include the case 70.

When the optical connector 1 is connected to another optical connector, the connection end face 10a of the ferrule 10 is butted against a ferrule included in another optical connector. In this case, as shown in FIG. 11, the regulated surface 12a of the ferrule 10 and the regulating portion 45 (regulating surface 45a) of the plug frame 40 are separated from each other, and the ferrule 10 retracts while resisting a biasing force directed forward by the biasing member 60. In other words, the ferrule 10 relatively moves rearward with respect to the plug frame 40 while compressing the biasing member 60 in the extension direction Z. At this time, the embedded fiber F1 (extension portion F1b) can be bent in the first flexure space 15a provided in the ferrule flange 10B and the second flexure space 24a provided in the temporary fixing member 20. Accordingly, damage to the embedded fiber F1 can be suppressed.

### (Production Method for Optical Connector 1)

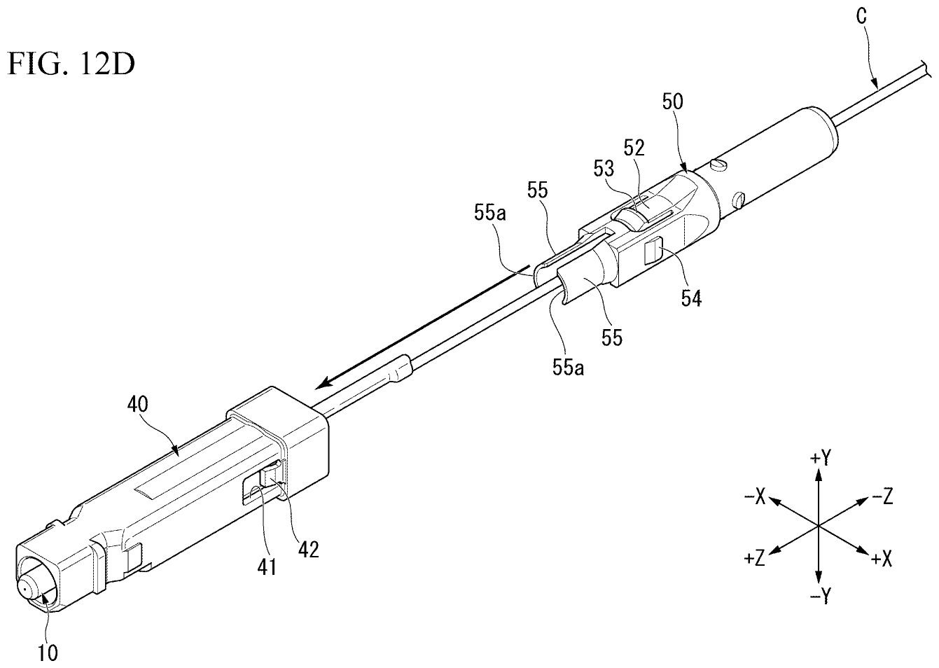

Next, an assembly method (production method) for the optical connector 1 will be described with reference to FIGS. 12A to 12D.

The production method for the optical connector 1 according to the present embodiment includes a preparation step, a fusion-splicing step, a heating-fixing step, an accommodation step, and a biasing locking step.

In the preparation step, the ferrule 10, the embedded fiber F1, the temporary fixing member 20, and the biasing member 60 described above are prepared. At this time, the embedded fiber F1 is inserted into the fiber hole 11 of the ferrule 10 (see FIG. 12A). In addition, the extension portion F1b of the embedded fiber F1 is inserted into the temporary fixing member 20. The biasing member 60 is disposed between the biased surface 12b of the ferrule 10 and the temporary biasing surface 21a of the temporary fixing member 20 in the extension direction Z, and biases the ferrule 10 forward. In addition, the engaged portion 14 of the ferrule 10 and the engaging portion 23 of the temporary fixing member 20 are engaged with each other such that the ferrule 10 and the temporary fixing member 20 are not separated by the biasing force of the biasing member 60, and the ferrule 10 and the temporary fixing member 20 are coupled.

In the preparation step, the biasing force exerted by the biasing member 60 against the ferrule 10 and the temporary fixing member 20 may be weak. More specifically, a magnitude of the biasing force of the biasing member 60 in the preparation step may be a minimum required magnitude such that disengagement between the engaged portion 14 and the engaging portion 23 caused by the ferrule 10 and the temporary fixing member 20 unexpectedly approaching each other in the extension direction Z does not occur. In addition, in the preparation step, a natural length and a spring constant of the biasing member 60, a distance between the biased surface 12b and the temporary biasing surface 21a in the extension direction Z, or the like may be appropriately adjusted such that the biasing member 60 exerts the minimum required biasing force as described above.

Next, the fusion-splicing step is performed. In the fusion-splicing step, a distal end of the connection fiber F2 is fusion-spliced to the rear end of the embedded fiber F1 (extension portion F1b) (see FIG. 12A).

Next, the heating-fixing step is performed. In the heating-fixing step, first, the connection point P at which the embedded fiber F1 and the connection fiber F2 are fusion-spliced to each other is positioned inside the above-described heat-shrinkable sleeve 30 (see FIG. 12B). In this case, as shown in the shown example, the connection point P and the tensile strength body T added to the connection point P may be disposed inside the heat-shrinkable sleeve 30. Thereafter, the heat-shrinkable sleeve 30 is heated and shrunk, and the heat-shrinkable sleeve 30 is fixed to an end portion (rear end portion) of the temporary fixing member 20. In addition, as described above, the heat-shrinkable sleeve 30 may be heat-shrunk such that the heat-shrinkable sleeve 30 tightens the plurality of projections 22a provided on the sleeve fixing portion 22.

Next, the accommodation step is performed. In the accommodation step, at least part of the ferrule 10, the temporary fixing member 20, the biasing member 60, and the like are accommodated in the plug frame 40 rearward (see FIG. 12C). In addition, at this time, the regulated surface 12a of the ferrule 10 may be brought into contact with the regulating portion 45 (regulating surface 45a) of the plug frame 40 (see also FIG. 3).

Next, the biasing locking step is performed. In the biasing locking step, the stop ring 50 is inserted from rearward of the plug frame 40 and each fourth claw portion 54 meshes with the first claw portion 42 of the plug frame 40, and thus, the stop ring 50 is locked to the plug frame 40 (see FIG. 12D). In this case, the third claw portion 52 of the stop ring 50 is inclined toward the radially inner side while the convex portion 53 of the stop ring 50 and the sliding concave portion 44 of the plug frame 40 are slid (see FIG. 11). Accordingly, the third claw portion 52 presses the heat-shrinkable sleeve 30 against the sleeve fixing portion 22.

In addition, when the stop ring 50 is inserted into the plug frame 40, the biasing surface 55a of the stop ring 50 is brought into contact with a rear end of the biasing member 60. More specifically, the stop ring 50 is moved forward in a state where the protrusion portion 55 included in the stop ring 50 is inserted into the concave portion 25 formed at the temporary fixing member 20 (see also FIG. 10). Then, the biasing surface 55a of the stop ring 50 moves forward of the temporary biasing surface 21a of the temporary fixing member 20. Accordingly, the biasing member 60 is interposed between the biased surface 12b of the ferrule 10 and the biasing surface 55a and is compressed in the extension direction Z, and the biasing member 60 is separated from the temporary biasing surface 21a of the temporary fixing member 20 (see also FIG. 3).

The biasing force exerted by the biasing member 60 against the ferrule 10 and the stop ring 50 after the biasing locking step is larger than the biasing force exerted by the biasing member 60 against the ferrule 10 and the temporary fixing member 20 in the preparation step. This is because the biasing member 60 is further compressed after the biasing locking step compared to during the preparation step. After the biasing locking step (after the assembly of the optical connector 1 is completed), it is desirable that the biasing force exerted by the biasing member 60 against the ferrule 10 and the stop ring 50 is sufficiently large. More specifically, when the optical connector 1 is connected to another optical connector, it is desirable that the biasing force is large enough to maintain a connection state between the connection end face 10a of the ferrule 10 and the ferrule included in another optical connector. In addition, the natural length and the spring constant of the biasing member 60, the distance between the biased surface 12b and the biasing surface 55a in the extension direction Z, or the like may be appropriately adjusted such that the biasing member 60 exerts a large biasing force as described above after the biasing locking step (after the assembly of the optical connector 1 is completed).

After each of the above steps is performed, the production (assembly) of the optical connector 1 is completed by attaching the case 70 to the plug frame 40 and attaching the boot 80 to the stop ring 50. Note that, the case 70 and the boot 80 may not be attached.

Next, actions and effects of the optical connector 1 having the above configuration and the production method for the optical connector 1 will be described.

In the related art, there has been known the fusion-splicing connector including the heat-shrinkable sleeve for protecting the connection point at which the connection fiber and the embedded fiber are fusion-spliced (see, for example, Patent Document 1). However, in such a fusion connector, in a case where the structure in which the spring is disposed between the ferrule and the spring bush is adopted, when the heat-shrinkable sleeve is heat-shrunk, not only the heat-shrinkable sleeve but also the spring bush biased by the spring can be heated. Thus, there is a possibility that strength of the spring bush decreases as a temperature increases due to heating and the spring bush is deformed by a biasing force by the spring.

On the other hand, in the optical connector 1 according to the present embodiment, the biasing force exerted by the biasing member 60 when the heat-shrinkable sleeve 30 is heated can be set to be smaller than the biasing force exerted by the biasing member 60 when the assembly of the optical connector 1 is completed. Accordingly, even though the temporary fixing member 20 is heated together when the heat-shrinkable sleeve 30 is heated and the strength of the temporary fixing member 20 decreases, it is possible to suppress the deformation of the temporary fixing member 20 and the optical connector 1 caused by the biasing force.

As described above, the optical connector 1 according to the present embodiment includes the ferrule 10 that has the first end E1 at which the connection end face 10a is provided and the second end E2 positioned opposite to the first end E1, and has the fiber hole 11 formed to open in the connection end face 10a, the embedded fiber F1 that has the insertion portion Fla inserted into the fiber hole 11 and the extension portion F1b extending rearward from the fiber hole 11, the connection fiber F2 fusion-spliced to the extension portion F1b of the embedded fiber F1, the temporary fixing member 20 into which the extension portion F1b is inserted, the heat-shrinkable sleeve 30 that is shrunk by heating, accommodates the connection point P at which the embedded fiber F1 and the connection fiber F2 are fusion-spliced, and is fixed to the end portion of the temporary fixing member 20, the plug frame 40 that has the frame body portion M accommodates at least part of the ferrule 10 and the temporary fixing member 20, and the regulating portion 45 regulating the relative movement of the ferrule 10 with respect to the frame body portion M in the extension direction Z, the tubular stop ring 50 that has the biasing surface 55a, accommodates at least part of the temporary fixing member 20 and at least part of the heat-shrinkable sleeve 30, and is locked to the plug frame 40, and the biasing member 60 that is disposed between the ferrule 10 and the biasing surface 55a in the extension direction Z, and biases the ferrule 10 forward.

With this configuration, the biasing force exerted by the biasing member 60 when the heat-shrinkable sleeve 30 is heated can be set to be smaller than the biasing force exerted by the biasing member 60 when the assembly of the optical connector 1 is completed. Accordingly, even though the heat-shrinkable sleeve 30 is used, the deformation of the optical connector 1 caused by the biasing force generated by the biasing member 60 can be suppressed.

In addition, the ferrule 10 has the engaged portion 14, and the temporary fixing member 20 has the engaging portion 23 that is engaged with the engaged portion 14 to regulate the relative movement of the ferrule 10 with respect to the temporary fixing member 20 in the extension direction Z and the temporary biasing surface 21a that faces the biasing member 60 in the extension direction Z. The biasing member 60 is away from the temporary biasing surface 21a in the extension direction Z. With this configuration, the biasing force exerted by the biasing member 60 when the heat-shrinkable sleeve 30 is heated can be reliably set to be smaller than the biasing force exerted by the biasing member 60 when the assembly of the optical connector 1 is completed. Accordingly, the deformation of the optical connector 1 caused by the biasing force generated by the biasing member 60 is more reliably suppressed.

In addition, the area of the biasing surface 55a is equal to or larger than the area of the temporary biasing surface 21a. With this configuration, the biasing force exerted by the biasing member 60 can be stabilized when the optical connector 1 is connected to another optical connector. Accordingly, the connection state between the connection end face 10a of the ferrule 10 and the ferrule included in another optical connector can be easily maintained.

In addition, the production method for the optical connector 1 according to the present embodiment includes preparing the ferrule 10 that has the first end E1 at which the connection end face 10a is provided and the second end E2 positioned opposite to the first end E1, and has the fiber hole 11 formed to open in the connection end face 10a, the embedded fiber F1 that has the insertion portion Fla inserted into the fiber hole 11 and the extension portion F1b extending rearward from the fiber hole 11, the temporary fixing member 20 into which the extension portion F1b is inserted, and which has the temporary biasing surface 21a, and the biasing member 60 that is disposed between the ferrule 10 and the temporary biasing surface 21a in the extension direction Z, and biases the ferrule 10 forward, fusion-slicing the connection fiber F2 to the extension portion F1b of the embedded fiber F1, shrinking the heat-shrinkable sleeve 30 by heating while positioning the connection point P at which the embedded fiber F1 and the connection fiber F2 are fusion-spliced inside the heat-shrinkable sleeve 30 and fixing the heat-shrinkable sleeve 30 to the end portion of the temporary fixing member 20, accommodating at least part of the ferrule 10, the temporary fixing member 20, and the biasing member 60 in the plug frame 40, and locking the tubular stop ring 50 having the biasing surface 55a to the plug frame 40, separating the biasing member 60 from the temporary biasing surface 21a while bringing the biasing surface 55a into contact with the biasing member 60, and sandwiching the biasing member 60 between the ferrule 10 and the biasing surface 55a.

With this configuration, the biasing force exerted by the biasing member 60 when the heat-shrinkable sleeve 30 is heated can be set to be smaller than the biasing force exerted by the biasing member 60 when the assembly of the optical connector 1 is completed. Accordingly, it is possible to produce (assemble) the optical connector 1 in which the deformation caused by the biasing force generated by the biasing member 60 is suppressed.

Note that, the technical scope of the present invention is not limited to the above-described embodiments, and various modifications can be made without departing from the spirit of the present invention.

For example, the optical connector 1 may have a plurality of embedded fibers F1 and a plurality of connection fibers F2. In addition, one optical fiber cable C may have a plurality of optical fibers (connection fibers F2), and the plurality of optical connectors 1 may be provided for one optical fiber cable C.

In addition, as long as the stop ring 50 can be locked to the plug frame 40, the configuration for locking the stop ring 50 to the plug frame 40 can be appropriately changed from the above-described embodiment. For example, each of the number of fourth claw portions 54 included in the stop ring 50 and the number of first claw portions 42 included in the plug frame 40 may not be two, may be one, or may be three or more. Alternatively, a projection may be provided on any one of the stop ring 50 and the plug frame 40, and a concave portion in which the projection is locked may be provided on the other.

In addition, in a case where the forward relative movement of the ferrule 10 with respect to the temporary fixing member 20 can be regulated, the structures of the engaged portion 14 included in the ferrule 10 and the engaging portion 23 included in the temporary fixing member 20 can be appropriately changed from the above-described embodiment. For example, in the above-described embodiment, the engaged portion 14 is a projection and the engaging portion 23 is a hole, but the engaged portion 14 may be a hole that caves in the radially inner side, and the engaging portion 23 may be a projection that protrudes toward the radially inner side. Alternatively, the ferrule 10 may not have the engaged portion 14, and the temporary fixing member 20 may not have the engaging portion 23.

In addition, the area of the biasing surface 55a of the stop ring 50 may be smaller than the area of the temporary biasing surface 21a of the temporary fixing member 20.

In addition, it is possible to appropriately replace the constituent elements in the above-described embodiment with well-known constituent elements and the above-described embodiment and modification examples may be appropriately combined without departing from the spirit of the present invention.

### REFERENCE SIGNS LIST

1: Optical connector
10: Ferrule
10a: Connection end face
11: Fiber hole
14: Engaged portion
E1: First end
E2: Second end
20: Temporary fixing member
21a: Temporary biasing surface
23: Engaging portion
30: Heat-shrinkable sleeve
40: Plug frame
M: Frame body portion
45: Regulating portion
50: Stop ring
55a: Biasing surface
60: Biasing member
F1: Embedded fiber
F1a: Insertion portion
F1b: Extension portion
F2: Connection fiber
P: Connection point
Z: Extension direction

What is claimed is:

1. An optical connector comprising:
a ferrule that has a first end at which a connection end face is provided and a second end positioned opposite to the first end, and has a fiber hole formed to open in the connection end face;
an embedded fiber that has an insertion portion inserted into the fiber hole, and an extension portion extending from the fiber hole toward the second end from the first end;
a connection fiber that is fusion-spliced to the extension portion of the embedded fiber;
a temporary fixing member into which the extension portion is inserted;
a heat-shrinkable sleeve that is shrunk by heating, accommodates a connection point at which the embedded fiber and the connection fiber are fusion-spliced, and is fixed to an end portion of the temporary fixing member;
a plug frame that has a frame body portion accommodating at least part of the ferrule and the temporary fixing member, and a regulating portion regulating relative movement of the ferrule with respect to the frame body portion in an extension direction in which the extension portion extends;
a tubular stop ring that has a biasing surface, accommodates at least part of the temporary fixing member and at least part of the heat-shrinkable sleeve, and is locked to the plug frame; and
a biasing member that is disposed between the ferrule and the biasing surface in the extension direction, and biases the ferrule in a direction from the second end toward the first end.

2. The optical connector according to claim 1,
wherein the ferrule has an engaged portion,
the temporary fixing member has an engaging portion that is engaged with the engaged portion and regulates relative movement of the ferrule with respect to the temporary fixing member in the extension direction, and a temporary biasing surface that faces the biasing member in the extension direction, and
the biasing member is away from the temporary biasing surface in the extension direction.

3. The optical connector according to claim 2,
wherein an area of the biasing surface is equal to or larger than an area of the temporary biasing surface.

4. A production method for an optical connector comprising:
preparing
a ferrule that has a first end at which a connection end face is provided and a second end positioned opposite to the first end, and has a fiber hole formed to open in the connection end face,
an embedded fiber that has an insertion portion inserted into the fiber hole and an extension portion extending from the fiber hole toward the second end from the first end,
a temporary fixing member into which the extension portion is inserted, and which has a temporary biasing surface, and
a biasing member that is disposed between the ferrule and the temporary biasing surface in an extension direction in which the extension portion extends, and biases the ferrule in a direction from the second end toward the first end;
fusion-slicing a connection fiber to the extension portion of the embedded fiber;
shrinking a heat-shrinkable sleeve by heating while positioning a connection point at which the embedded fiber and the connection fiber are fusion-spliced inside the heat-shrinkable sleeve and fixing the heat-shrinkable sleeve to an end portion of the temporary fixing member;
accommodating at least part of the ferrule, the temporary fixing member, and the biasing member in a plug frame; and
locking a tubular stop ring having a biasing surface to the plug frame, separating the biasing member from the temporary biasing surface while bringing the biasing surface into contact with the biasing member, and sandwiching the biasing member between the ferrule and the biasing surface.
